(19) United States
(12) Patent Application Publication
(10) Pub. No.: US 2014/0211460 A1
(43) Pub. Date: Jul. 31, 2014

(54) Portable lighting device

(71) Applicant: Richard J. Macor, Asbury, NJ (US)

(72) Inventor: Richard J. Macor, Asbury, NJ (US)

(21) Appl. No.: 13/815,073

(22) Filed: Jan. 29, 2013

(51) Int. Cl. F21L 4/02; F16B 7/04

(52) U.S. Cl. CPC F21L 4/02; F16B 7/0433
USPC 362/184; 403/188

(57) ABSTRACT

In one example embodiment, the present invention is a joining member configured to join at least two portable lighting devices such as flashlights. The joining member comprises means of attachment with each of the at least two portable lighting devices. And, the joining member is configured such that each of the at least two portable lighting devices is independently operational while attached with said joining member. In another example embodiment, the present invention is a primary portable lighting device that comprises a joining member configured to join at least two secondary portable lighting devices such as flashlights.

### FIELD OF THE INVENTION

The present invention relates to portable lighting devices such as battery powered flashlights, lanterns and the like.

### BACKGROUND OF THE INVENTION

Portable lighting devices such as battery powered flashlights, lanterns and the like have been around for many years and continue to evolve with recent improvements such as LED and Lithium Ion technologies, etc. Considering the many improvements in portable lighting devices over the years, there are still many areas where these devices can be improved. The inventor herein contemplates a portable lighting device that provides two or more times the battery life, illumination power, and versatility of a conventional, prior art portable lighting device.

### SUMMARY OF THE INVENTION

In one example embodiment, the present invention is a primary portable lighting device that comprises at least two secondary portable lighting devices such as flashlights. Each of the secondary lighting devices is operational while incorporated with the primary lighting device. And, each of the secondary lighting devices is detachable from the primary lighting device. In another example embodiment, the present invention is a joining member configured to join at least two portable lighting devices together, such as flashlights.

Accordingly, it is an objective of the present invention described herein that it can provide two or more times the battery life of a conventional prior art, portable lighting device such as a flashlight.

It is another objective of the present invention that it can provide two or more times the illumination power of a conventional prior art, portable lighting device such as a flashlight.

It is another objective of the present invention that it can provide two or more times the versatility of a conventional prior art, portable lighting device such as flashlight.

It is another objective of the present invention that it can provide two or more users each with their own independent, operational portable lighting device at the same time.

And, it is another objective of the present invention that it is commercially viable, simple in design, and cost-efficient to manufacture.

### BRIEF DESCRIPTION OF THE DRAWINGS

The present invention is more fully understood when the specification herein is taken in conjunction with the drawings appended hereto, wherein:

FIG. 1 shows a front perspective elevation view of an example embodiment of a primary portable lighting device; and,

FIG. 2 shows a top view of the primary portable lighting device shown in FIG. 1; and,

FIG. 3 shows a bottom view of the primary portable lighting device shown in FIGS. 1 and 2; and,

FIG. 4 shows a front perspective elevation view of another example embodiment of a primary portable lighting device; and,

FIG. 5 shows a left side elevation view of the primary portable lighting device shown in FIG. 4; and,

FIG. 6 shows a top view of the primary portable lighting device shown in FIGS. 4 and 5; and,

FIG. 7 shows a top view of another example embodiment of a primary portable lighting device; and,

FIG. 8 shows a front elevation view of the primary portable lighting device shown in FIG. 7; and,

FIG. 9 shows a top view of another example embodiment of a primary portable lighting device; and,

FIG. 10 shows a front elevation view of the primary portable lighting device shown in FIG. 9; and,

FIG. 11 shows a top view of an example embodiment of a joining member; and,

FIG. 12 shows a bottom view of the joining member shown in FIG. 11; and,

FIG. 13 shows a front elevation view of the joining member shown in FIGS. 11 and 12; and,

FIG. 14 shows an example embodiment of a light beam pattern of a primary portable lighting device having three secondary portable lighting devices at a predetermined distance; and,

FIG. 15 shows an example embodiment of a light beam pattern of the same primary portable lighting device producing the light beam pattern in FIG. 14, but at a farther distance than the distance of the light beam pattern shown in FIG. 14.

### DETAILED DESCRIPTION OF THE DRAWINGS

The various drawings provided herein are for the purpose of illustrating examples of the present invention and not for the purpose of limiting same. Therefore, the drawings herein represent only a few of the many possible examples, embodiments, variations and/or applications of the present invention.

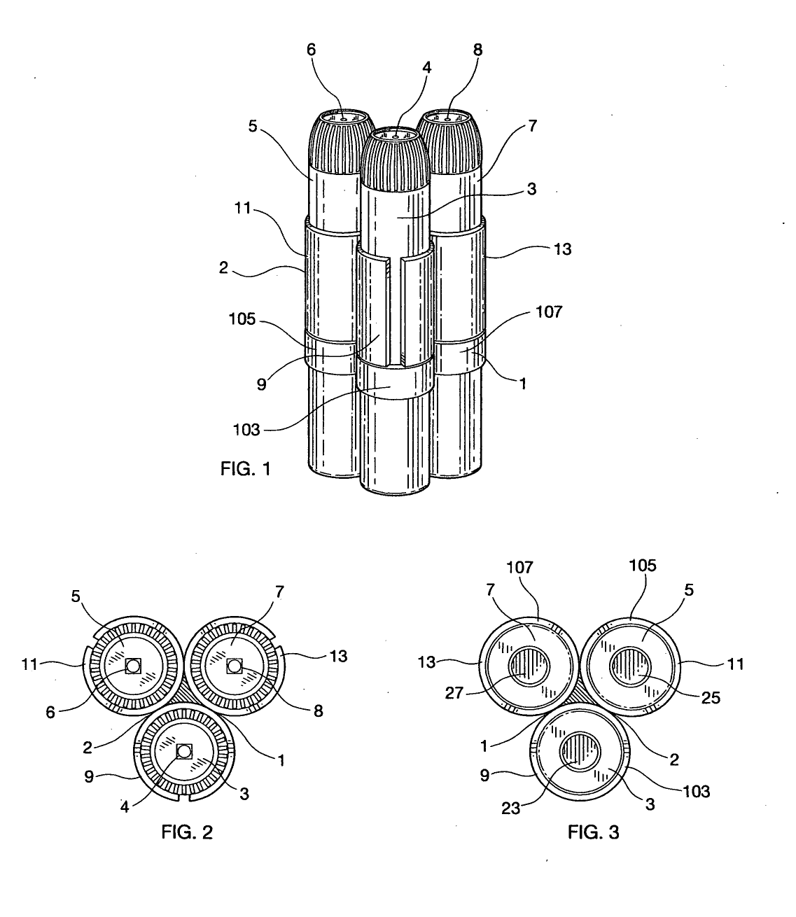

FIGS. 1, 2 and 3 together show a front perspective elevation view; a top view; and a bottom view respectively of an example embodiment of a primary portable lighting device 1. Primary portable lighting device 1 comprises three secondary portable lighting devices such as flashlights 3, 5 and 7 which are each operational while incorporated with primary lighting device 1. Each secondary lighting device has its own bulb and light switch. Secondary lighting device 3 has bulb 4, light switch 23, and stop band 103. Secondary lighting device 5 has bulb 6, light switch 25, and stop band 105. And, secondary lighting device 7 has bulb 8, light switch 27, and stop band 107. Each of the three secondary lighting devices 3, 5 and 7 is fully detachable from primary lighting device 1, and operational as an individual lighting device while detached from primary lighting device 1. Accordingly, flashlights 3, 5 and 7 could be detached and utilized by three separate individual users during the same period. This would provide primary portable lighting device 1 with a substantial increase in versatility over conventional prior art portable lighting devices. Secondary lighting devices 3, 5 and 7 are frictionally attached with joining member 2 by tubular retainers 9, 11 and 13 respectively. Each secondary portable lighting device may be individually detached from joining member 2 of primary lighting device 1 by pulling downward (using FIG. 1) with sufficient force to overcome the frictional retention. And, each secondary portable lighting 3, 5, and 7 may be individually reattached with joining member 2 of primary lighting device 1 by pushing upward until properly positioned and stopped in place by band stops 103, 105 and 107 respectively (using FIG. 1). In the upright position shown in FIG. 1, primary portable lighting device 1 could also act as a lantern with three power levels of illumination. Of course, a small handle or light diffuser (fixed or movable) could also be added without departing from the scope of the present invention.

Joining member 2 is configured to join three secondary lighting devices 3, 5 and 7 using retainers 9, 11 and 13. Retainer 9 frictionally holds secondary lighting device 3, while retainer 11 frictionally holds secondary lighting device 5, while retainer 13 frictionally holds secondary lighting device 7. Of course, there could be many other means by which secondary lighting devices 3, 5 and 7 could be attached with joining member 2 of primary lighting device 1 without departing from the scope of the present invention. For example, magnets, Velcro, plastic or metal clips, plastic or metal spring clips, plastic or metal male/female devices, elastic bands, plastic or metal nuts and bolts, etc. could also be used as a means by which secondary lighting devices 3, 5 and 7 could be attached with joining member 2.

In this example embodiment of the present invention, primary portable lighting device 1 comprises three secondary portable lighting devices. In some preferred embodiments of the present invention there are three secondary portable lighting devices, however, the present invention may have as little as two secondary portable lighting devices, or more than three secondary lighting devices.

In this example embodiment of the present invention, each secondary lighting device 3, 5 and 7 produces a beam of light, and, all three of the secondary lighting devices are positioned such that the beams of light overlap at a predetermined distance. In some preferred embodiments of the present invention, at least two secondary lighting devices are positioned such that the beams of light overlap at a predetermined distance to enhance illumination at a predetermined distance.

In this example embodiment of the present invention, each secondary portable lighting device 3, 5 and 7 is the same in structure as the others. Considering economics and efficiency, in some preferred embodiments of the present invention at least one secondary lighting device is structurally the same as at least another secondary lighting device.

In this example embodiment of the present invention, each secondary portable lighting device 3, 5 and 7 is powered by at least one disposable battery. However, applicant also contemplates a primary portable lighting device wherein each of the secondary lighting devices can be powered by at least one rechargeable battery, and, the primary portable lighting device includes means for recharging the secondary lighting devices together during overlapping time periods.

Depending upon whether a user wishes to use the illumination capability of one, two, or three of the secondary lighting devices individually or at the same time, and/or provide one, two, or three users each with their own individual lighting device at the same time, the example embodiment of the present invention shown in FIGS. 1, 2 and 3 can provide three times the battery life, three times the illumination power, and three times the versatility of a conventional prior art, portable lighting device.

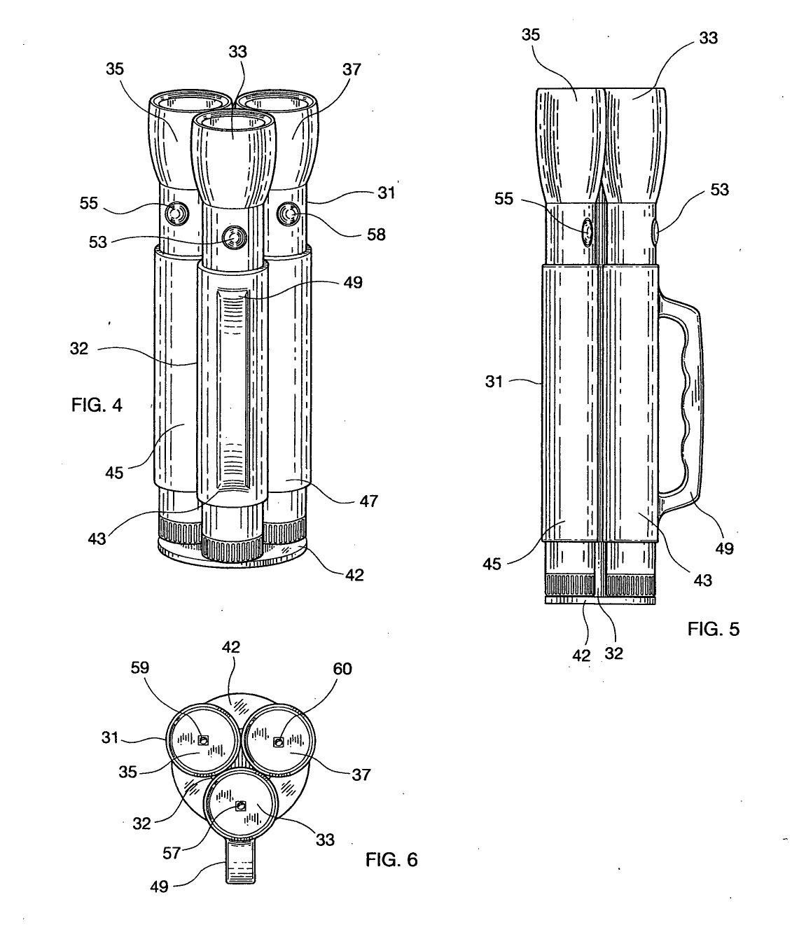

FIGS. 4, 5 and 6 together show a front perspective elevation view; a left side elevation view, and a top view respectively of an example embodiment of a primary portable lighting device 31. Primary portable lighting device 31 comprises three secondary portable lighting devices such as flashlights 33, 35 and 37 which are each operational while incorporated with primary lighting device 31. Each secondary lighting device has its own bulb and light switch. Secondary lighting device 33 has bulb 57 and light switch 53. Secondary lighting device 35 has bulb 59 and light switch 55. And, secondary lighting device 37 has bulb 60 and light switch 58. Each of the three secondary lighting devices 33, 35 and 37 is fully detachable from primary lighting device 31, and operational as an individual lighting device while detached from primary lighting device 31. Accordingly, flashlights 33, 35 and 37 could be detached and utilized by three separate individual users during the same period. This would provide primary portable lighting device 31 with a substantial increase in versatility over conventional prior art portable lighting devices. Secondary lighting devices 33, 35 and 37 are frictionally attached with joining member 32 by plastic tubular retainers 43, 45 and 47 respectively. Each secondary portable lighting device may be removed and individually detached from joining member 32 of primary lighting device 31 by pulling upward (as shown in FIGS. 4 and 5) with sufficient force to overcome the frictional retention. And, each secondary portable lighting device may be individually reattached with joining member 32 of primary lighting device 31 by inserting into a tubular retainer and pushing downward (as shown in FIGS. 4 and 5) with sufficient force to overcome the frictional retention. Each of secondary portable lighting devices 33, 35 and 37 is properly positioned and stopped in place by lower base 42 of joining member 32 as shown. In the upright position shown in FIGS. 4 and 5, primary portable lighting device 31 could also act as a lantern with three power levels of illumination. Of course, a diffuser (fixed or movable) configured to diffuse light in the lantern mode could also be added without departing from the scope of the present invention.

Joining member 32 is configured to join three secondary lighting devices 33, 35 and 37 using retainers 43, 45 and 47 respectively. Retainer 43 frictionally holds secondary lighting device 33, while retainer 45 frictionally holds secondary lighting device 35, while retainer 47 frictionally holds secondary lighting device 37. Of course there could be many other means by which secondary lighting devices 33, 35 and 37 could be attached with joining member 32 of primary lighting device 31 without departing from the scope of the present invention. For example, magnets, Velcro, plastic or metal clips, plastic or metal spring clips, plastic or metal male/female devices, elastic bands, plastic or metal nuts and bolts, etc. could also be used as a means by which secondary lighting devices 33, and 37 could be attached with joining member 32. In this example embodiment of the present invention, secondary lighting devices 33, 35 and 37 each utilize two “D” size batteries making primary portable lighting device 31 relatively large. Accordingly, Primary portable lighting device 31 has a handle 49 to accommodate this industrial, example embodiment of a present invention.

In this example embodiment of the present invention, primary portable lighting device 31 comprises three secondary portable lighting devices. In some preferred embodiments of the present invention there are three secondary portable lighting devices, however, the present invention may have as little as two secondary portable lighting devices, or more than three secondary lighting devices.

In this example embodiment of the present invention, each secondary lighting device 33, 35 and 37 produces a beam of light, and, all three of the secondary lighting devices are positioned such that the beams of light overlap at a predetermined distance. In some preferred embodiments of the present invention, at least two secondary lighting devices are positioned such that the beams of light overlap at a predetermined distance.

In this example embodiment of the present invention, each secondary portable lighting device 33, 35 and 37 is the same in structure as the others. Considering economics and efficiency, in some preferred embodiments of the present invention, at least one secondary lighting device is structurally the same as at least another secondary lighting device.

In this example embodiment of the present invention, each secondary portable lighting device 33, 35 and 37 is powered by at least one disposable battery. However, applicant also contemplates a primary portable lighting device wherein each of the secondary lighting devices can be powered by at least one rechargeable battery, and, the primary portable lighting device includes means for recharging the secondary lighting devices together during overlapping time periods.

Depending upon whether a user wishes to use the illumination capability of one, two, or three of the secondary lighting devices individually or at the same time, and/or provide one, two, or three users each with their own individual lighting device at the same time, the example embodiment of the present invention shown in FIGS. 4, 5 and 6 can provide three times the battery life, three times the illumination power, and three times the versatility of a conventional prior art, portable lighting device.

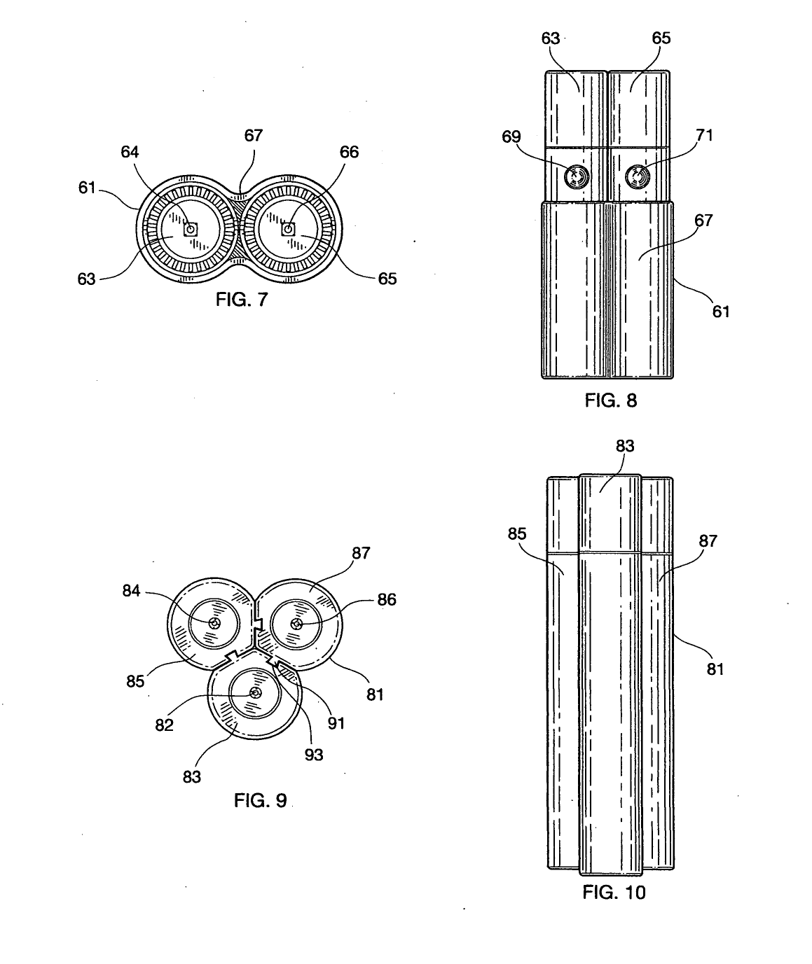

FIGS. 7 and 8 together show a top view and a front elevation view respectively, of an example embodiment of a primary portable lighting device 61. Primary portable lighting device 61 comprises two secondary portable lighting devices such as flashlights 63 and 65 which are each operational while incorporated with primary lighting device 61. Each secondary lighting device has its own bulb and light switch. Secondary lighting device 63 has bulb 64 and light switch 69. Secondary lighting device 65 has bulb 66 and light switch 71. Each of the two secondary lighting devices 63 and 65 is fully detachable from primary lighting device 61, and operational as an individual lighting device while detached from primary lighting device 61. Accordingly, flashlights 63 and 65 could be detached and utilized by two separate individual users during the same period. This would provide primary portable lighting device 61 with a substantial increase in versatility over conventional prior art portable lighting devices. Joining member 67 is configured to join secondary portable lighting devices 63 and 65.

Depending upon whether a user wishes to use the illumination capability of one or both secondary lighting devices individually or at the same time, and/or provide one or two users each with their own individual lighting device at the same time, the example embodiment of the present invention shown in FIGS. 7 and 8 can provide two times the battery life, two times the illumination power, and two times the versatility of a conventional prior art, portable lighting device.

FIGS. 9 and 10 together show a top view and front elevation view respectively, of an example embodiment of a primary portable lighting device 81. Primary portable lighting device 81 comprises three secondary portable lighting devices such as flashlights 83, 85 and 87 which are each operational while incorporated with primary lighting device 81. Each secondary lighting device has its own bulb and light switch. Secondary lighting device 83 has bulb 82; and, secondary lighting device 85 has bulb 84; and, secondary lighting device 87 has bulb 86. Each of the three secondary lighting devices 83, 85 and 87 is fully detachable from primary lighting device 81, and operational as an individual lighting device while detached from primary lighting device 81. Accordingly, flashlights 83, 85 and 87 could be detached and utilized by three separate individual users during the same period. This would provide primary portable lighting device 81 with a substantial increase in versatility over conventional prior art portable lighting devices.

In this example embodiment of the present invention, each of the three secondary portable lighting devices has means to attach with and detach from another secondary portable lighting device. In some preferred embodiments of the present invention, a primary portable lighting device can comprise at least one secondary portable lighting device with means to attach with and detach from at least another secondary portable lighting device. Seen best in FIG. 9, is an example embodiment of an attachment/detachment means with dovetail protrusion 91 of Flashlight 87 interlocking with dovetail groove 93 of flashlight 83. Each flashlight 83, 85 and 87 has a dovetail protrusion and a dovetail groove running longitudinally for attachment with and detachment from another secondary lighting device of the same structure. Accordingly, this example embodiment of a primary portable lighting device does not necessarily require a joining member.

In this example embodiment of the present invention, primary portable lighting device 81 comprises three secondary portable lighting devices. In some preferred embodiments of the present invention there are three secondary portable lighting devices; however, the present invention may have as little as two secondary portable lighting devices or more than three secondary lighting devices.

In this example embodiment of the present invention, each secondary lighting device 83, 85 and 87 produces a beam of light, and, all three of the secondary lighting devices are positioned such that the beams of light overlap at a predetermined distance. In some preferred embodiments of the present invention, at least two secondary lighting devices are positioned such that the beams of light overlap at a predetermined distance.

In this example embodiment of the present invention, each secondary portable lighting device 83, 85 and 87 is the same in structure as the others. Considering economics and efficiency, in some preferred embodiments of the present invention, at least one secondary lighting device is structurally the same as at least another secondary lighting device.

In this example embodiment of the present invention, each secondary portable lighting device 83, 85 and 87 is powered by at least one disposable battery. However, applicant also contemplates a primary portable lighting device wherein each of the secondary lighting devices can be powered by at least one rechargeable battery, and, the primary portable lighting device includes means for recharging the secondary lighting devices together during overlapping time periods.

Depending upon whether a user wishes to use the illumination capability of one, two, or three of the secondary lighting devices individually or at the same time, and/or provide one, two, or three users each with their own individual lighting device at the same time, the example embodiment of the present invention shown in FIGS. 9 and 10 can provide three times the battery life, three times the illumination power, and three times the versatility of a conventional prior art, portable lighting device.

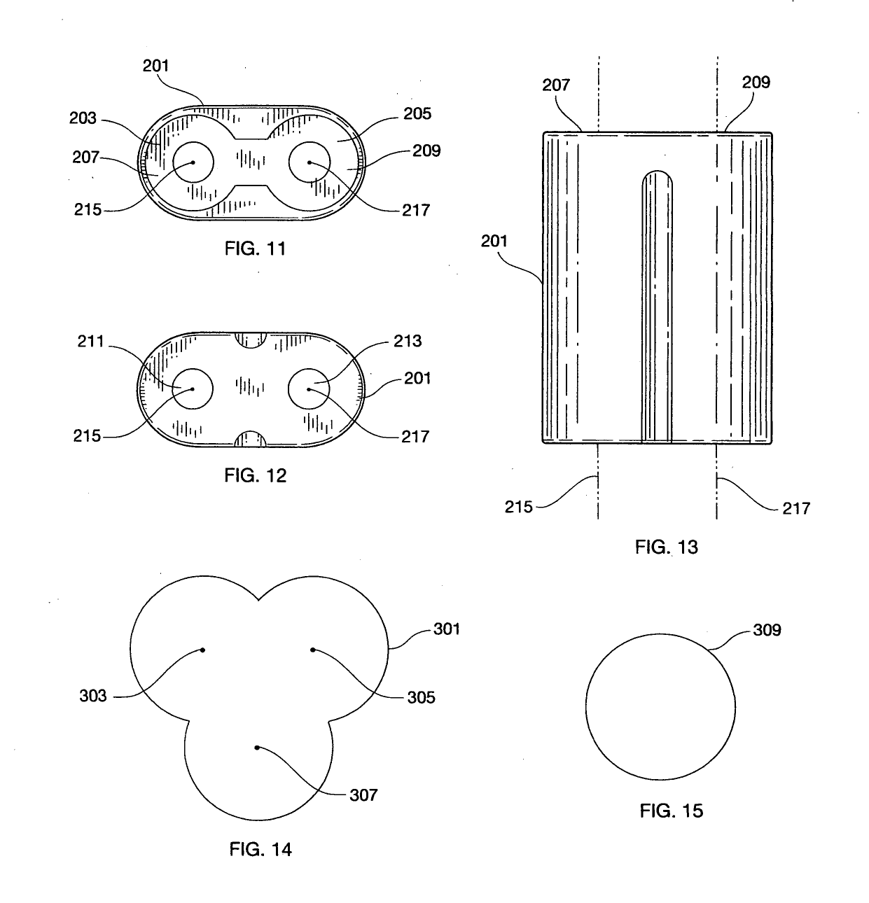

FIGS. 11, 12 and 13 show a top view, bottom view and front elevation view of an example embodiment of a joining member 201 respectively. Joining member 201 is configured to join two portable lighting devices together such as two flashlights (not shown). Joining member 201 comprises means of attachment with each of the two flashlights. Joining member 201 is molded from an elastic, rubber-like material and has inner cavity 203 configured to hold and attach with one of the two flashlights (not shown) by way of frictional engagement; and, cavity 205 is configured to hold and attach with one of the two flashlights (not shown) by way of frictional engagement. Each of inner cavities 203 and 205 of joining member 201 is further configured such that each of the two lighting devices (not shown) is operational while attached with joining member 201.

Each of inner cavities 203 and 205 of joining member 201 comprises a forward opening and a rear area. Inner cavity 203 has forward opening 207 and rear area 211; and, inner cavity 205 has forward opening 209 and rear area 213. Forward opening 207 provides access to the inner cavity 203 to accept and attach with one of the two flashlights; and, forward opening 209 provides access to the inner cavity 205 to accept and attach with one of the two flashlights. Each inner cavity has a major axis passing through the centers of the rear area and the forward opening. Accordingly, inner cavity 203 has major axis 215 passing through the centers of forward opening 207 and rear area 211; and, inner cavity 205 has major axis 217 passing through the centers of forward opening 209 and rear area 213. And, inner cavities 203 and 205 are configured for convergence of the major axes 215 and 217 respectively at a predetermined distance. This will allow the beams of the two attached flashlights to overlap for more intensity at a predetermined distance.

In FIG. 14, triangular shaped light beam 301 is an example embodiment of a light beam pattern of a primary portable lighting device (not shown) seen at several feet away. Axes 303, 305 and 307 are each the center of an individual light beam from one of three secondary lighting devices of the primary lighting device (not shown).

In FIG. 15, circular shaped light beam 309 is an example embodiment of a light beam pattern of the same primary portable lighting device as that used to create the light beam pattern in FIG. 14, except as seen at 50 feet away. Here the axes of the three light beams created by the three secondary lighting devices converge and overlap at a predetermined distance. In some preferred embodiments of the present invention, at least two secondary lighting devices are positioned such that the beams of light overlap at a predetermined distance to enhance illumination at a predetermined distance. This distance could be any distance intended by the manufacturer. For example, a manufacturer may have a consumer model primary lighting device with at least two secondary lighting devices positioned such that the beams of light overlap at around 30 feet so that the light beams appear as one focused light beam at distances of 10 to 50 feet. And, another manufacturer may have an industrial model primary lighting device with at least two secondary lighting devices positioned such that the beams of light overlap at around 60 feet so that the light beams appear as one focused light beam at distances of 30 to 90 feet, etc. Of course, the distance at which the at least two light beams converge and overlap could be made adjustable so a user could fine tune and adjust the distance at which the at least two light beams converge and overlap for maximum illumination.

Upon reading and understanding the specification of the present invention described above, modifications and alterations will become apparent to those skilled in the art. It is intended that all such modifications and alterations be included insofar as they come within the scope of the patent as claimed or the equivalence thereof.

1-18. (canceled)

19. A joining member configured to join at least two portable lighting devices such as flashlights, said joining member comprising means of attachment with each of said at least two portable lighting devices, said joining member further being configured such that each of said at least two portable lighting devices is independently operational while attached with said joining member.

20. The joining member of claim 19, wherein each of said at least two portable lighting devices is detachable from said joining member for use as an individual portable lighting device.

21. The joining member of claim 20, wherein said joining member is configured to join at least three portable lighting devices.

22. The joining member of claim 20, wherein each of said at least two portable lighting devices produces a beam of light, and, said joining member is configured so that said beams of light overlap at a predetermined distance.

23. A joining member of claim 20, wherein at least one of said at least two portable lighting devices is structurally the same as another portable lighting device.

24. A joining member comprising at least two inner cavities, each said inner cavity configured to accept a portable lighting device such as flashlight, each of said at least two inner cavities having a forward opening and a rear area, wherein each forward opening provides access to the inner cavity; each inner cavity having a major axis passing through the centers of the rear area and the forward opening; wherein, the at least two inner cavities are configured for convergence of the major axes at a predetermined distance.

25. The joining member of claim 24, wherein the rear area further comprises a rear opening.

26. The joining member of claim 24, wherein the rear area further comprises a closed base.

27. The joining member of claim 19, wherein said joining member is configured to join at least three portable lighting devices.

28. The joining member of claim 19, wherein each of said at least two portable lighting devices produces a beam of light, and, said joining member is configured so that said beams of light overlap at a predetermined distance.

29. A joining member of claim 19, wherein at least one of said at least two portable lighting devices is structurally the same as another portable lighting device.

30. A joining member of claim 19, wherein said joining member further comprises a handle.

31. A joining member of claim 20, wherein said joining member further comprises a handle.

32. A joining member of claim 24, wherein said joining member further comprises a handle.

33. A primary portable lighting device comprising a joining member configured to join at least two secondary portable lighting devices such as flashlights, said joining member comprising means of attachment with each of said at least two secondary portable lighting devices, said joining member further being configured such that each of said at least two secondary portable lighting devices is independently operational while attached with said joining member.

34. The primary portable lighting device of claim 33, wherein each of said at least two secondary portable lighting devices is detachable from said joining member for use as an individual portable lighting device.

35. The primary portable lighting device of claim 33, wherein said primary portable lighting device includes at least three secondary portable lighting devices such as flashlights.

36. The primary portable lighting device of claim 33, wherein each of said at least two secondary portable lighting devices produces a beam of light, and, said at least two secondary portable lighting devices are positioned such that the beams of light overlap at a predetermined distance.

37. The primary portable lighting device of claim 33, wherein at least one of said at least two secondary portable lighting devices is structurally the same as another secondary portable lighting device.

38. The primary portable lighting device of claim 33, wherein each of said at least two secondary portable lighting devices is powered by at least one disposable battery.

39. The primary portable lighting device of claim 33, wherein each of said at least two secondary portable lighting devices is powered by at least one rechargeable battery, and, said primary portable lighting device includes means for recharging said at least two secondary portable lighting devices during overlapping time periods.

40. The primary portable lighting device of claim 34, wherein said primary portable lighting device includes at least three secondary portable lighting devices such as flashlights.

41. The primary portable lighting device of claim 34, wherein each of said at least two secondary portable lighting devices produces a beam of light, and, said at least two secondary portable lighting devices are positioned such that the beams of light overlap at a predetermined distance.

42. The primary portable lighting device of claim 34, wherein at least one of said at least two secondary portable lighting devices is structurally the same as another secondary portable lighting device.

43. The primary portable lighting device of claim 34, wherein each of said at least two secondary portable lighting devices is powered by at least one disposable battery.

44. The primary portable lighting device of claim 34, wherein each of said at least two secondary portable lighting devices is powered by at least one rechargeable battery, and, said primary portable lighting device includes means for recharging said at least two secondary portable lighting devices during overlapping time periods.

45. The primary portable lighting device of claim 36, wherein said primary portable lighting device does not include a joining member, but rather, each of said at least two secondary portable lighting devices comprises means to attach with and detach from at least another secondary portable lighting device.
